(19) United States
(12) Patent Application Publication
(10) Pub. No.: US 2026/0015983 A1
(43) Pub. Date: Jan. 15, 2026

(54) EXHAUST REBREATHE ENABLED MIXING CONTROLLED COMPRESSION IGNITION

(71) Applicant: Marquette University, Milwaukee, WI (US)

(72) Inventors: Adam Dempsey, Germantown, WI (US); Tyler Johnston, Oconomowoc, WI (US)

(73) Assignee: Marquette University, Milwaukee, WI (US)

(21) Appl. No.: 18/907,023

(22) Filed: Oct. 4, 2024

Related U.S. Application Data
(60) Provisional application No. 63/670,367, filed on Jul. 12, 2024.

(51) Int. Cl. F02D 41/00; F02B 37/24; F02D 41/14

(52) U.S. Cl. CPC F02D 41/006; F02B 37/24; F02D 13/0261; F02D 41/1446; F02M 26/01

(57) ABSTRACT

A mixing controlled combustion (MCC) engine includes a cylinder and a piston defining a combustion chamber. A direct injector is coupled to the cylinder and configured to deliver a low cetane fuel to the combustion chamber. An intake valve is operable to sequentially open to draw air into the combustion chamber. An exhaust valve is operable to sequentially open to expel exhaust from the combustion chamber. The exhaust valve is further operable to open during a portion of a time that the intake valve is open to draw exhaust back into the combustion chamber as rebreathed exhaust to mix with the air to form a combustion chamber gas.

### CROSS-REFERENCE TO RELATED APPLICATIONS

This application claims priority of U.S. Provisional Patent Application No. 63/670,367, filed on Jul. 12, 2024. The contents of which is hereby incorporated by reference in its entirety.

### BACKGROUND

Internal combustion engines (ICE) are fundamental technologies used in the day-to-day life of people and industries. Spark ignition (SI) engines are widespread for comparatively light-duty applications. SI engines are well adapted to burn low carbon intensity fuels with low fuel reactivity or high octane number, for example blends of gasoline and ethanol, from pure gasoline to pure ethanol. SI engines lack the performance characteristics desired for robust heavy-duty operation. SI engines are not able to meet the transient and high torque at low-speed requirements of heavy-duty applications. Knock is a common limiting factor to obtain high load at reasonable efficiency in heavy-duty SI engines. Alternative fuels like ethanol and methanol exhibit high latent heat of vaporization and excellent knock resistance but exhibit large thermal sensitivity and excessive cyclic variability near the lean-limit. SI engines further lack good transient snap-torque response in fear of knock and pre-ignition. The transient nature and peak load demands of heavy-duty engine applications limit the applicability of SI engines in heavy-duty applications.

Therefore, heavy-duty engines are predominantly compression ignition (CI) diesel fuel engines. The mixing-controlled combustion (MCC) process is well adapted to higher reactivity or higher cetane number fuels, such as diesel fuel. The MCC process enables high fuel conversion efficiency and robust power delivery over a wide operational range. The MCC process of fossil diesel fuel however comes at the cost of high emissions of carbon dioxide (CO2), nitrogen oxides (NOx), and soot.

A natural solution to combat high emissions is to replace diesel fuel with cleaner burning low carbon intensity fuels in the MCC process, thus the engine can maintain its performance characteristics enabled by MCC. However, clean burning low carbon intensity fuels, such as naphtha, ethanol, methanol, natural gas, propane, hydrogen, and ammonia-all have low reactivity (cetane number) and are therefore not conducive to the MCC process. MCC engines require fuels with a cetane number of ˜40 or higher to ensure reliable and robust autoignition and combustion. This corresponds to an approximate research octane number of ˜45 or lower. Thus, the proposed MCC concept with exhaust rebreathe ignition assistance is aimed at fuels with cetane number of less than 40 and octane number greater than 45. In order to burn low-cetane fuels in MCC, some form of ignition assistance must be provided to initiate combustion. Heightened in-cylinder temperatures during engine operation will increase the propensity of the fuel to auto-ignite. Numerous solutions have been attempted, however, none have produced the desired performance to provide a suitable alternative to diesel MCC. One such attempt included the use of glow plugs, typically used for startup diesel ignition assistance, operationally to continuously increase chamber temperature. Mueller et al. “Glow Plug Assisted Ignition and Combustion of Methanol in an optical diesel engine” SAE Tech Pap. DOI: 10.4271/20Jan. 1, 2004, found this to combust low-cetane fuels in an MCC engine, however, glow plug technology exhibits much greater power requirements for operational glow plug use along with an expected significant reduction in glow plug life when used under such power requirements and operated continuously.

Dual-fuel systems seek to combine diesel and a low cetane fuel—where the more reactive diesel fuel serves as the ignition source. In premixed systems, a diesel pilot is used to initiate combustion of the premixed low cetane fuel. However, these systems exhibited a lack of combustion stability over the operational range, increased HC emissions at middle to low loads, and still have challenges with knock and pre-ignition like an SI engine. Additionally, a dual-fuel system requires additional complexity to design, operate, and maintain two fuel systems.

U.S. Pat. No. 10,458,311, entitled “Internal Combustion Engine” and U.S. Pat. No. 11,840,954, entitled “Spark Ignited Engine with a Pre-Chamber, A Prechamber and an Adapter Insert for the Engine” both disclose prechambers for use with an internal combustion engine and are incorporated by reference herein.

### BRIEF DISCLOSURE

Examples of high octane, low cetane, low carbon intensity and renewal fuel sources include naphtha, ethanol, methanol, hydrogen, natural gas, propane, ammonia, and gasoline/ethanol fuel blends, such as E10, E15, and E85.

An example of a mixing controlled combustion (MCC) engine includes a cylinder and a piston disposed for reciprocal motion within the cylinder. A combustion chamber is defined between the cylinder and the piston. A direct injector is coupled to the cylinder and configured to deliver a fuel having a cetane number of less than 40 to the combustion chamber. An intake valve is operable to sequentially open to draw air into the combustion chamber. An exhaust valve is operable to sequentially open to expel exhaust from the combustion chamber. The exhaust valve is further operable to open during a portion of a time that the intake valve is open to draw exhaust back into the combustion chamber as rebreathed exhaust to mix with the air to form a combustion chamber gas.

Examples of the MCC engine further include an intake primary cam, an exhaust primary cam, and an exhaust rebreathe cam. The intake primary cam is configured to open the intake valve and the exhaust rebreathe cam is configured to open the exhaust valve during the portion of the time that the intake valve is open. A camshaft in a single overhead camshaft arrangement, wherein the camshaft comprises the intake primary cam, the exhaust primary cam, and the exhaust rebreathe cam. An intake camshaft and an exhaust camshaft arranged in a double overhead camshaft arrangement, wherein the intake camshaft comprises the intake primary cam and the exhaust camshaft comprises the exhaust primary cam and the exhaust rebreathe cam. A portion of the time that the intake valve is open occurs during a second half of the time that the intake valve is open. A valve lift maximum extent of the exhaust valve during the portion of the time that the intake valve is open occurs after a valve lift maximum extent of the intake valve occurs.

In additional examples of the MCC engine, a variable geometry turbocharger (VGT) is connected downstream of the exhaust valve. The VGT is operable to vary the quantity of trapped residuals in the rebreathed exhaust. The VGT is operable to control the pressure in the exhaust port in response to an identification of the fuel. The VGT is operable to control the pressure in the exhaust port in response to engine operating conditions. A pressure of the rebreathed exhaust is 220 kPa or more. Up to 50% of the combustion chamber gas is rebreathed exhaust. Between 10-30% the combustion chamber gas is rebreathed exhaust. An intake valve close (IVC) temperature in the cylinder is at least 480 K. A start of injection (SOI) temperature is at least 1200 K.

A method of mixing controlled compression ignition (MCCI) of a low reactivity fuel includes opening an intake valve for an intake stroke to draw air into a cylinder. An exhaust valve is opened for exhaust rebreathe during the intake stroke to draw exhaust gas and exhaust residuals into the cylinder. The exhaust valve and the intake valve are closed. A compression stroke is initiated at a cylinder gas temperature elevated by the exhaust gas and exhaust residuals. The low reactivity fuel is direct injected into the cylinder. The low reactivity fuel is compression ignited.

In additional examples of the method of MCCI include a pressure of the exhaust gas in an exhaust port is controlled with a variable geometry turbocharger (VGT) connected to the exhaust port downstream of the exhaust valve. The pressure in the exhaust port during the exhaust rebreathe is 220 kPa or more and up to 50% of gas in the combustion chamber is exhaust gas and exhaust residuals. The exhaust valve is opened for an exhaust stroke. The intake valve is opened for the intake stroke with a primary intake cam. The exhaust valve is opened for the exhaust stroke with a primary exhaust cam. The exhaust valve is opened for exhaust rebreathe with a rebreathe cam. A temperature in the combustion chamber when the intake valve closes is at least 480 K.

### BRIEF DESCRIPTION OF THE DRAWINGS

FIG. 1 depicts an example of a mixing controlled combustion cylinder with exhaust rebreathe ignition assistance.

FIG. 2 is crank angle timing diagram of an example of exhaust rebreathe camshaft valve lift profiles.

FIG. 3 is an exemplary graph of in-cylinder gas temperature vs. crank angle for elevated intake air temperature (comparative technology) with ethanol fuel.

FIG. 4 is an exemplary graph of in-cylinder gas pressure and heat release rate vs. crank angle for elevated intake air temperature (comparative technology) with ethanol fuel.

FIG. 5 is an exemplary graph of in-cylinder gas temperature vs. crank angle for exhaust rebreathe over exhaust manifold pressure variation with ethanol fuel as disclosed.

FIG. 6 is an exemplary graph of in-cylinder trapped exhaust residuals and trapped gas temperature over exhaust manifold pressure variation with ethanol fuel as disclosed.

FIG. 7 are graphs of the disclosed exhaust rebreathe ignition assistance technology with ethanol fuel using an unpiloted single injection, and a piloted double injection (pilot and main injection) strategy.

FIG. 8 is a flow chart depicting an example of a method of mixing controlled compression ignition with exhaust rebreathe.

### DETAILED DISCLOSURE

Investigation into improved mixing-controlled combustion (MCC) processes for low cetane fuels have been reported by the inventors in Dempsey et al. “A System to Enable Mixing Controlled Combustion with High Octane Fuels Using a Prechamber and High-Pressure Direct Injector” Front. Mech. Eng. 7:637665 (2021); Dempsey et al. “Prechamber Enabled Mixing Controlled Combustion—A Fuel Agnostic Technology For Future Low Carbon Heavy-Duty Engines,” SAE Technical Paper 2022-01-0449; Zeman et al. “Assessment of Design and Location of an Active prechamber igniter to enable mixing-controlled combustion of ethanol in heavy-duty engines,” International Journal of Engine Research (2023); Zeman et al. “Characterization of Flex-Fuel Prechamber Enabled Mixing-Controlled Combustion with Gasoline/Ethanol Blends at High Load,” ASME Journal of Engineering for Gas Turbines and Power (2024); Nsaif et al. “Reducing Methane Emissions from Lean Burn Natural Gas engines with Prechamber Ignited Mixing-Controlled Combustion,” ASME Journal of Engineering for Gas Turbines and Power (2024); and “Mixing-Controlled Compression Ignition with Exhaust Rebreathe on A Heavy-Duty Engine—A CFD Modelling Investigation comparing Diesel Fuel an Ethanol,” Proceedings of the ASME ICE Forward Conference, ICEF 2023-109548 (2023), each of which are incorporated by reference in their entireties.

Ethanol is an attractive low carbon renewable fuel to lower ICE emissions, especially for SI engine applications due it its high-octane number. However, heavy-duty vehicles have operating cycles that are challenging for SI engines and thus mixing-controlled compression ignition (MCCI) operation is the preferred approach. Use of a low carbon, renewable fuel, like ethanol, in MCCI engines, requires an ignition assistance source. Through investigation and research, the inventors have developed a system of exhaust rebreathe as an ignition assistance source either alone or in combination with other ignition assistance source(s) to ignite ethanol in a MCCI engine. The exhaust rebreathe reopens the exhaust valve during the intake stroke to recirculate exhaust products from the previous cycle into the cylinder to trap hot exhaust residuals and heat the intake charge. The elevated trapped cylinder gas temperature aids in the auto-ignitability of low reactive fuels, like ethanol.

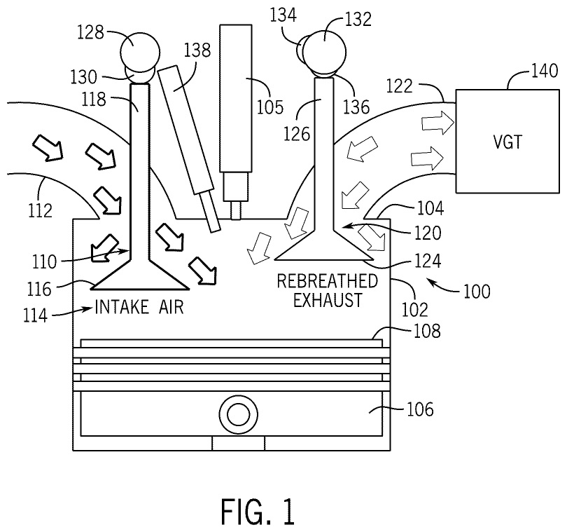

FIG. 1 presents an example of a system 100 for mixing controlled combustion cylinder with exhaust rebreathe ignition assistance. The system 100 includes a cylinder 102 and a cylinder head 104. A piston 106 reciprocates within the cylinder 102. The piston 106 has a crown 108 and a chamber 114 is defined between the crown 108, the cylinder 102, and a cylinder head 104. A direct injector 105 injects high pressure plumes of fuel into the chamber 114 for combustion. An intake valve 110 controls the flow of fresh air through an intake port 112 into the chamber 114. The intake valve 110 extends through the cylinder head 104 and includes a valve head 116 and a valve stem 118. An exhaust valve 120 similarly controls the flow of exhaust gases between the chamber 114 and an exhaust port 122. The exhaust valve 120 includes a valve head 124 and a valve stem 126.

A camshaft 128 controls the timing of the opening and closing of the intake valve 110 with a primary cam 130 extending from the camshaft 128. Rotation of the camshaft 128 sequentially engages the valve stem 118 with the primary cam 130. The intake valve 110 is biased to a closed position by a spring (not depicted). Engagement of the valve stem 118 with the primary cam 130 causes the intake valve 110 to open, while disengagement of the valve stem 118 from the primary cam 130 causes the intake valve to close. Recognizing that FIG. 1 is schematic in nature, the physical interaction between the primary cam 130 and the intake valve 110 may include other mechanical components not depicted in FIG. 1. A camshaft 132 controls the timing of the opening and closing of the exhaust valve 120. It is recognized that in a single overhead camshaft (SOHC) arrangement, the camshafts 128 and 132 are the same camshaft, while in a double overhead camshaft (DOHC) arrangement, the camshafts 128 and 132 are two separate components. However it is understood that the present disclosure recognizes and incorporates both of these camshaft configurations. The camshaft 132 includes a primary cam 134 and a rebreathe cam 136. Rotation of the camshaft 132 causes the primary cam 134 and the rebreathe cam 136 to sequentially engage and disengage from the valve stem 126 of the exhaust valve 120. The exhaust valve 120 is biased to a closed position by a spring (not depicted). Engagement of the valve stem 126 with the primary cam 134 causes the exhaust valve 120 to open, and disengagement of the valve stem 126 from the primary cam 130 causes the intake valve to close as is recognized in an exhaust cycle. As will be described in further detail herein, the rebreathe cam 136 further engages the valve stem 126 to produce a controlled rebreathe of a portion of the exhaust gases. Recognizing that FIG. 1 is schematic in nature, the physical interaction between the primary cam 134, rebreathe cam 136 and the exhaust valve 120 may include other mechanical components not depicted in FIG. 1.

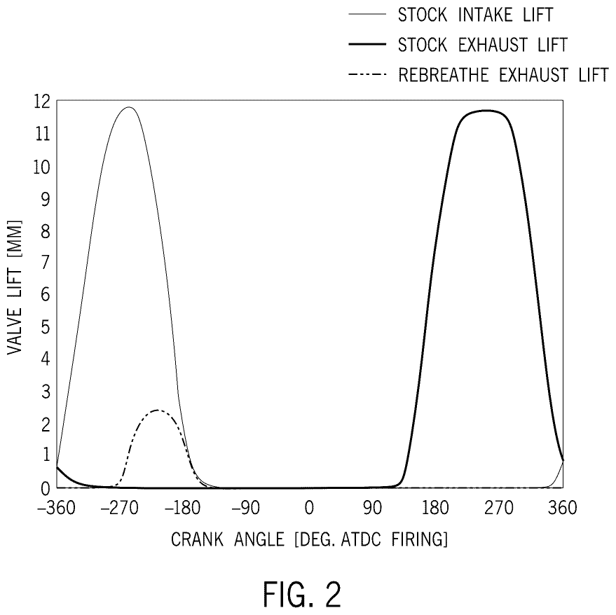

FIG. 2 is a graph of valve lift for the intake, exhaust, and exhaust rebreathe with respect to associated crank angle in degrees after top dead center (ATDC). As can be seen in FIG. 2, the rebreathe opening of the exhaust valve is to a lesser distance extent than that of the stock exhaust cycle. Additionally, the exhaust rebreathe occurs with the end of the intake, with the exhaust rebreathe valve lift maximum extent occurring after (in crank angle degrees (CAD) the maximum extent of the intake valve lift. Halfway through the intake stroke, the exhaust valve reopens inducing hot exhaust products from the exhaust port into the cylinder increasing the trapped IVC temperature and residual content.

A non-limiting example of operational parameters for the exhaust rebreathe are provided below in Table 1:

| Parameters | Values | |
|---|---|---|
| Valve Opening | −270° | ATDC |
| Valve Closing | −164° | ATDC |
| Valve Duration | 106 | CAD |

| | |
|---|---|
| Peak Lift and Location | 2.43 mm at −218° ATDC |

For the purposes of using exhaust rebreathe as an ignition assistance source, the amount of trapped residuals will dictate the increase in in-cylinder temperatures prior to combustion. With the fixed exhaust rebreathe valve event (e.g. as dictated by crankshaft/cam design), the exhaust pressure can be varied to change the amount of trapped residuals. The trapped residual content, defined as the percentage of internal exhaust gas recirculation (i-EGR), was determined using the following equation:

$$i - EGR = \frac{{y}_{CO 2 , cyl , IVC}}{{y}_{CO 2 , cyl , EVO}} \qquad ( 1 )$$

Where y_{CO2,cyl,IVC} is the mass fraction of CO2 in the cylinder at intake valve close (IVC) and y_{CO@cyl,EVO} is the mass fraction of CO2 in the cylinder at exhaust valve open (EVO).

For a given rebreathe camshaft design, the amount of rebreathe exhaust, or trapped residuals, is controlled by the ratio of the exhaust manifold pressure to the intake manifold pressure. This pressure manifold ratio is controlled by a variable geometry turbocharger (VGT) 140 to vary the quantity of trapped residuals required to ignite the low-reactive fuel over the entire engine operating range. The VGT 140 does this by controlling the mean exhaust back pressure during the exhaust rebreathe. The VGT 140 is exemplarily communicatively connected to a controller of the vehicle and/or specific to the engine. The VGT 140 exemplarily receives control signals responsive to engine operating conditions including but not limited to fuel used, engine speed, load (IMEP_{g}), intake pressure, intake temperature, exhaust pressure, or exhaust temperature. The VGT 140 is operable, in turn in response to the control signals to adjust the mean exhaust back pressure during the exhaust rebreathe to provide the trapped residuals and rebreathed exhaust to maintain MCCI.

Using low reactivity fuels in conventional MCCI requires higher in-cylinder temperature at the time of fuel injection, prior to combustion. Larger amounts of trapped residuals are desired for increasing the in-cylinder temperature at IVC. Also the exhaust residuals reduce the ratio of specific heats of the trapped gases. These effects tend to counteract the heating contribution from the rebreathed exhaust and ultimately the exhaust residuals can slow the rate of combustion.

The higher temperatures at IVC result in higher compressed gas temperatures near the start of injection, aiding in the auto-ignitability of the fuel desirable for MCCI. An increase in i-EGR from an increase in exhaust backpressure advanced the start of combustion as exemplarily represented as CA10. With the increase of trapped exhaust residuals, a decrease in oxygen concentration occurs due to the dilution of the in-cylinder charge with the combustion products from the previous cycle. While the peak heat-release rate decreased due to the shorter ignition delay and less fuel participating in the “premixed” phase of MCCI combustion. Although the in-cylinder charge is diluted, the ignition delay is shortened indicating that the temperature induced by the exhaust products during the rebreathe event strongly impacts ignition chemistry and outweighs the oxygen dilution impacts of the trapped combustion products. These competing effects of heating, dilution, and reduced specific heat ratio due to exhaust rebreathe are considered when providing MCCI of low reactivity fuels.

The present disclosure further includes an optional local heating source 138. The local heating source 138 may exemplarily be a glow plug or a fast high power air heater. Such local heating source is used at engine start-up to heat the cylinder. After the engine is started, the exhaust temperatures are high enough for examples of the exhaust rebreathe to be effective and ignite the low-reactive fuel. Once combustion occurs, the local heating source 138, exemplarily the glow plug, will shut off to extend its life mitigating the previously acknowledged limits to glow plug use.

A single cylinder engine geometry of a Caterpillar C9.3B heavy-duty diesel engine was used for the testing and investigation of the combustion system as described herein. Table 2 below provides engine and operating parameters of this test setup. However, it will be recognized from the present disclosure that these are merely exemplary and other engine parameters and operating conditions may be used while remaining within the scope of the disclosure.

| Component | Parameter | Value | |
|---|---|---|---|
| Engine | Displaced Volume | 1.55 | L |
| | Bore | 115 | mm |
| | Stroke | 149 | mm |
| | Connecting rod length | 217 | mm |
| | Compression ratio | 17 | |
| | Intake valve open | 350° | ATDC |
| | Intake valve close | −152° | ATDC |
| | Peak intake valve lift | 11.8 | mm |
| | Exhaust valve open | 138° | ATDC |
| | Exhaust valve close | −351° | ATDC |
| | Peak exhaust valve lift | 11.7 | mm |
| Direct | Number of nozzles | 6 | |
| Injector | Nozzle diameter | 205 | μm |
| | Umbrella angle | 135° | |
| | Injection Pressure | 75 | MPa |
| | Injection method | Single main | |
| Operating | Engine Speed | 2200 | rpm |
| Condition | Load (IMEP_{g}) | ~4.2 | bar |
| | Intake pressure | 1.2 | bar |
| | Intake Temperature | 35° | C. |
| | Exhaust pressure | 1.3 | bar |
| | Exhaust temperature | 285° | C. |

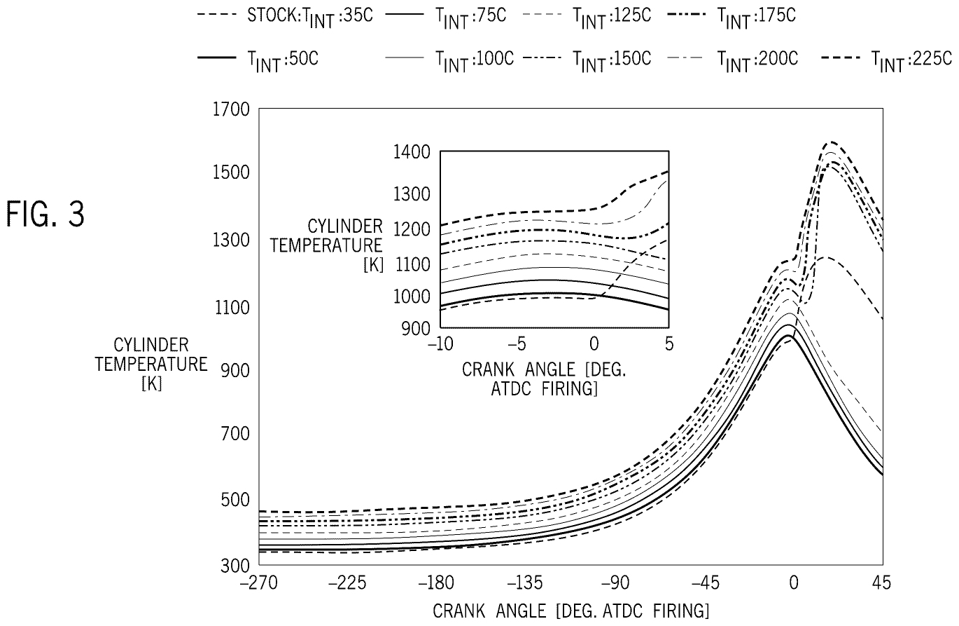

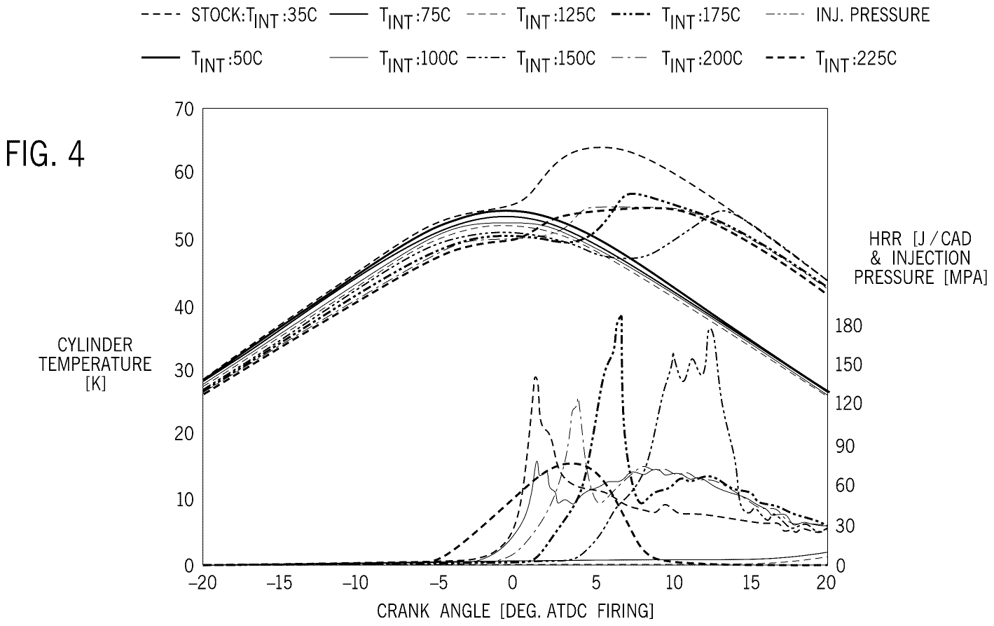

In an MCC engine, it is important for the fuel to ignite quickly, within ˜0.1 to 1 millisecond after the start of fuel injection. FIG. 4 shows that for the stock diesel engine described here, the ignition delay is 5 crank angle degrees, which at 2200 rpm, is 0.37 ms. This is achieved with an in-cylinder gas temperature at the start of injection of approximately 950K. To achieve ignition delays with ethanol similar to diesel fuel at 0.37 ms, a temperature at start of injection (SOI) of approximately 1100K is required. The stock valve lift profiles without rebreathe at elevated intake temperatures ranging from 50° C. to 225° C. at 25° C. increments were investigated at the engine and operating parameters of Table 2. At an intake air temperature of ˜ 150° C. an IVC temperature of 440K and SOI temperature of ˜1120K are achieved as shown in FIG. 3, which is a graph of cylinder temperature of elevated intake air temperature with pure ethanol based upon Degrees ATDC firing. As shown in FIG. 3, an intake temperature below 150° C., or an IVC temperature below ˜440K, is not high enough to ignite pure ethanol in MCCI at the high speed, light load condition of ˜4.2 bar gross IMEP and engine speed of 2200 RPM represented in the test. To achieve similar ignition delays with pure ethanol to that of diesel in MCCI, an IVC temperature of ˜480 and SOI temperature of ˜1200 K are required.

FIG. 4 is a graph of cylinder pressure and heat release rate (HRR) for various intake temperatures and the stock diesel operation for comparison. Similar ignition delays with pure ethanol compared to diesel fuel at the tested engine and operating parameters were observed at an intake air temperature of 225° C. Start of combustion (SOC) as represented by CA10 are presented below in Table 3:

| | CA10 |
|---|---|
| Case | (deg. ATDC) |
| Stock (diesel) | 1.3 |
| Tᵢₙₜ 150° C. | 7.9 |
| Tᵢₙₜ 175° C. | 4.9 |
| Tᵢₙₜ 200° C. | 3.4 |
| Tᵢₙₜ 225° C. | 2.0 |

However, an intake air temperature of 225° C. would require significant intake air heating, increasing complexity and likely to result in a reduction in overall efficiency. As described herein, exhaust rebreathe is used to achieve elevated IVC and SOI temperatures without the complexity and efficiency losses to heat the air prior to intake. Exhaust rebreathe does present the further challenge of a dilution effect to the fresh intake air and thus, it can be expected that temperatures higher than those found for heated intake air above are required in a rebreathe strategy.

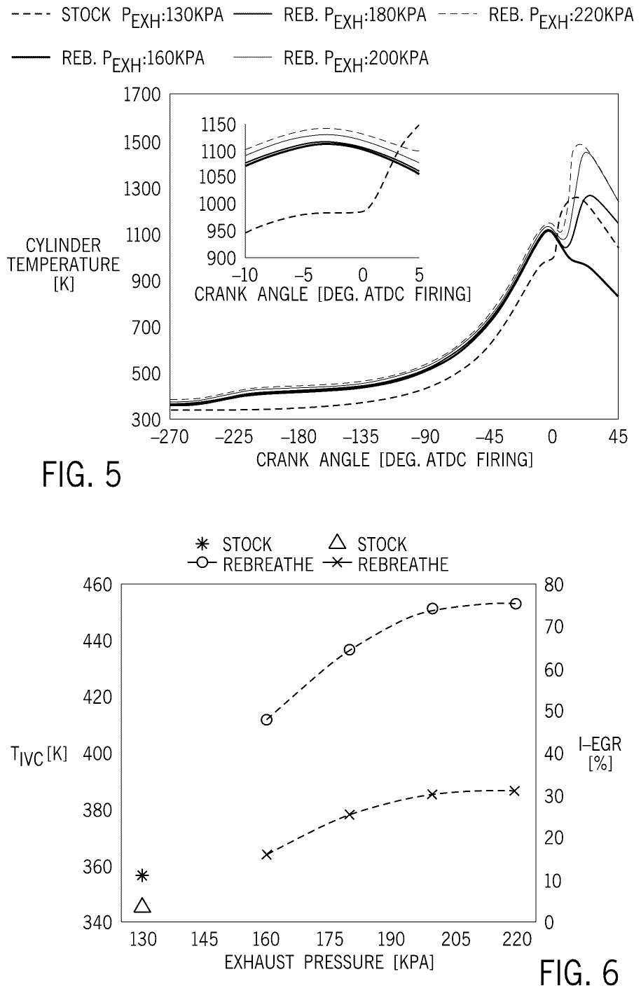

Given that exhaust valve lift during the rebreathe cycle is a fixed value, the mean exhaust back pressure can be changed, through operation of the VGT 140 to control exhaust pressure and exhaust residuals. FIG. 5 presents the cylinder temperature across a range of crank angles for various exhaust rebreathe pressures, ranging from a stock 130 kPa to 220 kPa. This graph shows the impact of exhaust rebreathe on heating the cylinder gases as an ignition assistance of direct injected ethanol fuel. The amount of reprieve can be controlled by the exhaust pressure, and by trapping approximately 10-30% internal exhaust residuals, this can raise the cylinder gas temperature by approximately 100° C. at the tested engine and operating parameters. This 100° C. increase in cylinder gas temperature leads to a ˜150° C. increase near TDC with the injected fuel, enabling auto-ignition of the ethanol fuel.

Table 4 presents the SOC as represented by CA10 for the three tested exhaust rebreathe pressures that achieved combustion in FIG. 5.

| | CA10 |
|---|---|
| Case | (deg. ATDC) |
| Stock (diesel) | 1.3 |
| Rebreathe 180 kPa | 9.0 |
| Rebreathe 200 kPa | 7.0 |
| Rebreathe 220 kPa | 6.5 |

The SOC converged to the stock diesel combustion as the rebreathe pressure increased with 220 kPA rebreathe pressure providing combustion with an approximate 5 CAD delay. FIG. 6 is a graph of IVC temperature and iEGR % at various rebreathe pressures. As can be seen from Table 4, and FIGS. 5 and 6, an IVC temperature of 440 K is exceeded at a mean exhaust back pressure of 200 kPa. However, due to the dilution for the rebreathed exhaust lower in the ratio of specific heats and oxygen concentration of the in-cylinder charge, a SOI temperature of ˜1200 K is not achieved. These results indicate that achieving a cylinder gas temperature of ˜1200 K is needed to achieve diesel-like ignition delays with ethanol fuel. Comparing Table 3 to Table 4, the dilution effect of the rebreathed exhaust gasses can be seen in the delayed SOC values.

Referring to FIG. 6, the highest IVC temperature was achieved at the highest mean exhaust pressure of 220 kPa. At this mean exhaust pressure, an increase in IVC temperature and i-EGR % compared to the stock diesel is ˜100 K and ˜25% respectively. As an IVC temperature and SOI temperature of ˜480K and ˜1200K, respectively, are desired to achieve ignition delays with ethanol similar to the stock diesel case, an i-EGR % above ˜30% must be achieved. Based upon these results, a higher exhaust rebreathe pressure than 220 kPa and/or a larger and/or longer rebreathe exhaust valve lift is needed to introduce additional exhaust residuals to achieve the target IVC and SOI temperatures.

Table 5 presents the engine performance metrics of stock diesel to the best performing tested ethanol cases for the intake air heating and exhaust rebreathe strategies.

| | Stock | Ethanol: Tᵢₙₜ | Ethanol: Reb. |
|---|---|---|---|
| Parameters | Diesel | 225° C. | P 220 kPa |
| T_{IVC} (K) | 356 | 483 | 453 |
| Ignition | 9.3 | 10.0 | 14.5 |
| Delay (CAD) | | | |
| N_{comb} (%) | 99.50 | 99.90 | 99.76 |
| PMEP (kPa) | 46 | 40 | 131 |
| NIE (%) | 42 | 42 | 32 |

The no-rebreathe elevated intake air temperature of 225° C. case with pure ethanol had a similar ignition delay to the sock diesel case. For the exhaust rebreathe 220 kPa mean exhaust pressure, the PMEP and NIE suffer from the high exhaust pressure. However, similarities in combustion efficiency to the stock diesel case and an IVC temperature near the no-rebreathe elevated intake air temperature of 225° C. with pure ethanol case was achieved. While the tested 220 kPa rebreathe exhibited an ignition delay, the 220 kPa rebreathe provided a combustion equivalent to ˜175° C. elevated intake air temperature with a T_{IVC} of ˜460 K and about a 100K increase over the stock diesel operation.

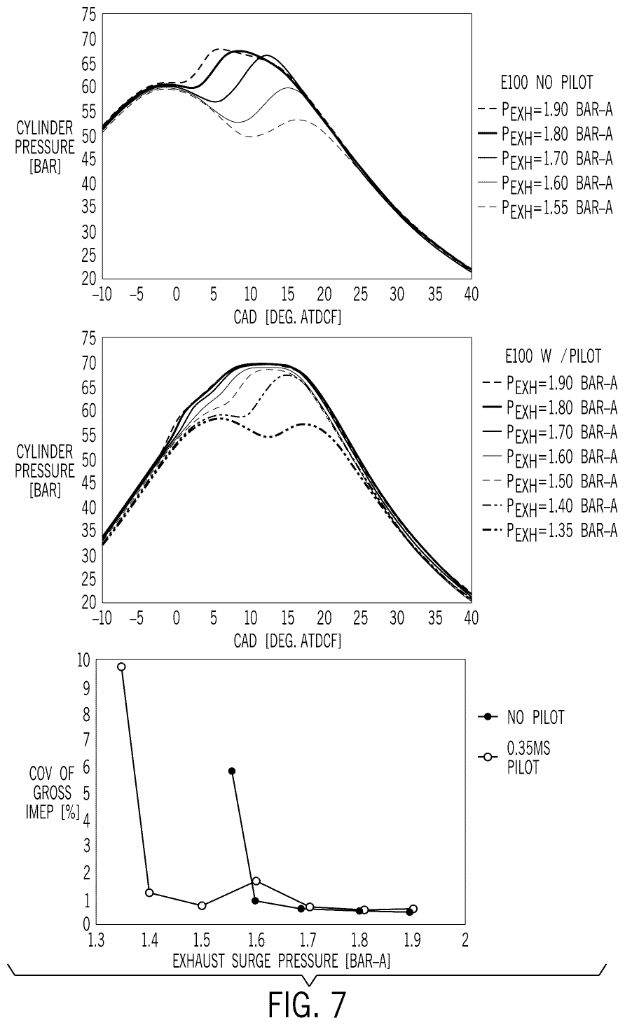

FIG. 7 presents graphs of experimental data from a compression ignition diesel engine converted to run on ethanol fuel with exhaust rebreathe. As shown, the combustion is improved as the exhaust pressure is increased-meaning more exhaust rebreathing, the graphs show that pressures exceeding ˜1.4 to ˜1.6 bar-abs are required to achieve ethanol combustion in this configuration at this operating condition. The graphs also show that pilot injections are effective at reducing the exhaust rebreathe requirements to achieve successful combustion with lower trapped residual levels. In an example of a piloted combustion, a pilot injection of 5%-25% of the total cycle fueling is provided at between −25 to −5 CAD prior to the start of the main fuel injection. This shortens the main injection ignition delay by increasing the residence time for fuel in the chamber, which gives more time for the chemical reactions responsible for ignition.

To address the ignition delays observed in the investigated conditions for exhaust rebreathe ignition assistance of ethanol when using a single injection (without a pilot injection) in a compression ignition engine, additional heat or ignition aid may be needed. This additional heat may come from a variety of sources, including, but not limited to: using pilot injections as discussed above, preheating the intake air, strategically using a glow plug, using an actively fueled prechamber, or increasing the amount of exhaust rebreathed. Use of one or more of these additional heat sources will achieve an IVC temperature and SOI temperature of at least 480 K and 1200K, respectively. For example, intake air could be preheated by flowing over or past a heat exchange surface to capture residual heat from elsewhere in the engine.

As described above, examples may already incorporate a glow plug for use in initiating combustion. While it was noted that continuous glow plug use is associated with rapid degradation of the glow plug. However, as a source of secondary heating of the chamber, the glow plug may be operated at lower power and could be phased relative to the combustion cycle to improve glow plug performance and longevity, while providing heat to the cylinder in addition to the rebreathed exhaust.

As previously noted, concurrent work into systems for MCC of low cetane fuels includes the use of an actively fueled prechamber, for example as described in PCT/US2024/037766 entitled, “Prechamber Design for Cylinder Periphery Mounted Igniter in Fuel Agnostic Prechamber Enabled Mixing-Controlled Combustion” and PCT/US2024.037773 entitled, “Operational Strategy for Fuel Agnostic Prechamber Enabled Mixing-Controlled Combustion” which are incorporated by reference herein in their entireties. In examples, such prechambers, actively fueled with the same low cetane fuel as the main injection and sparked in advance of the main injection can provide further additional heat to the cylinder to promote compression ignition in combination with exhaust rebreathe. Since prechamber operation in such an example provide heat in combination with the exhaust rebreathe, it will be recognized that smaller fuel volumes and/or more advanced spark timings may be used compared to examples wherein the prechamber is solely providing the ignition assistance.

Exhaust rebreathe can be increased with larger peak exhaust valve rebreathe lift, increased lift duration, and/or increased rebreathe pressure. The valve rebreathe lift and lift duration are exemplarily functions of the design and/or position of the rebreathe cam 136 described above. The rebreathe pressure is exemplarily controlled by operation of the VGT 140. These exhaust rebreathe adjustments will achieve an IVC temperature and SOI temperature of at least 480 K and 1200K respectively. Phasing of the rebreathe exhaust lift location earlier in the intake stroke may further increase the pressure difference between the exhaust port and cylinder during the rebreathe event aiding in exhaust draw.

The specific examples provided herein use ethanol fuel and exhaust rebreathe valve lift design and may be specific to the engine parameters of the engine used and engine operating conditions described therein. However, it will be recognized from this example, that the exhaust rebreathe strategy for ignition assistance for hard to ignite/low cetane fuels (as represented by ethanol) in a compression ignition engine. The exact exhaust rebreathe requirements will change with fuel and operating condition, but as described in reference to the examples above, the exhaust rebreathed levels can be controlled by exhaust pressure and exhaust rebreathe camshaft design. In light of the vast alternative fuels landscape to reduce carbon emission from engines, the goal of exhaust rebreathe ignition assistance technology is to enable fuel agnostic CI engines for heavy-duty applications. Ethanol is a very high octane (low reactivity) alternative fuel for CI engines, and thus an exemplar fuel for demonstration of the fuel agnostic capabilities of the disclosed design. With an exhaust rebreathe configuration that is capable of providing adequate ignition assistance for ethanol, the engine would ultimately be able to also use gasoline, naptha, ethanol, methanol, and blends thereof interchangeably, as those fuels are more reactive than ethanol, as well as providing a system that is backward compatible with using diesel, biodiesel, and renewable diesel fuels.

As described above, the exhaust rebreathe in response to engine intra-operational conditions is controlled with the VGT 140 to adjust the mean exhaust back pressure during the exhaust rebreathe. Similarly, while the shaft and cam configuration may be fixed in the engine hardware, control of the mean exhaust back pressure by the VGT may be provided in response to the presence of different fuels, thereby furthering the ability of the disclosed system to operate when provided with a range of input fuels as described above.

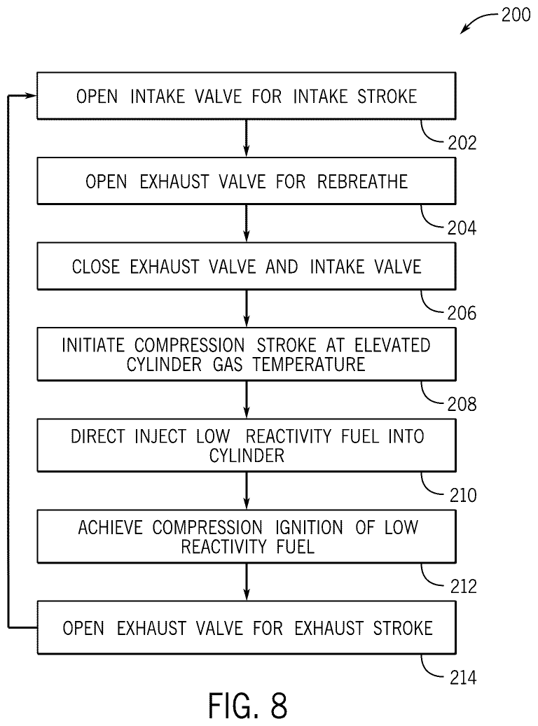

FIG. 8 is a flowchart that depicts an example of a method 200 of MCCI in accordance with the disclosure herein. It will be recognized that this example is non-limiting and that more or fewer steps may be taken while remaining within the scope of the disclosed method. Methods as disclosed herein may be performed with the structures and arrangements as described herein, or may be performed with other arrangements as will be recognized from the present disclosure.

The method 200 exemplarily starts by opening the intake valve 110 for the intake stroke at 202. It will be recognized that in a four-stroke engine sequence that the operation of the engine is cyclical and repetitive and therefore, the method may occur starting at any point along the flow chart of FIG. 8. During the intake stroke, fresh air is dawn into the cylinder through the intake valve. At 204, the exhaust valve 120 is opened for combustion gas rebreathe as described above. This occurs during the intake stroke while the intake valve is also open. The exhaust valve exemplarily opens around halfway through the time that the intake valve is open, and is open to a smaller valve displacement and duration than the intake valve. The open exhaust valve draws heated exhaust gas and exhaust residuals into the cylinder preheating the cylinder, elevating the temperature of the gas within the cylinder. At 206 the exhaust valve and the intake valve are closed, ending the intake stroke.

At 208 the compression stroke is initiated at the elevated temperature cylinder gas temperature. Near the top of the compression stroke, low reactivity fuel, for example ethanol, is direct injected into the cylinder chamber at 210. This forms high-pressure plumes of the low reactivity fuel within the cylinder headspace. At 212 the heat from the elevated temperature cylinder gas and the compression of that gas reaches a temperature to achieve compression ignition of the low reactivity fuel. This initiates the power stroke. Lastly, the exhaust valve is opened at 214 for the exhaust stroke, clearing the high temperature exhaust gas and exhaust residuals from the cylinder.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A mixing controlled combustion (MCC) engine comprising:
a cylinder;
a piston disposed for reciprocal motion within the cylinder, a combustion chamber defined between the cylinder and the piston;
a direct injector coupled to the cylinder and configured to deliver a fuel having a cetane number of less than 40 to the combustion chamber;
an intake valve operable to sequentially open to draw air into the combustion chamber; and
an exhaust valve operable to sequentially open to expel exhaust from the combustion chamber;
wherein the exhaust valve is further operable to open during a portion of a time that the intake valve is open to draw exhaust back into the combustion chamber as rebreathed exhaust to mix with the air to form a combustion chamber gas.

2. The MCC engine of claim 1, further comprising an intake primary cam, an exhaust primary cam, and an exhaust rebreathe cam.

3. The MCC engine of claim 2, wherein the intake primary cam is configured to open the intake valve and the exhaust rebreathe cam is configured to open the exhaust valve during the portion of the time that the intake valve is open.

4. The MCC engine of claim 3, further a camshaft in a single overhead camshaft arrangement, wherein the camshaft comprises the intake primary cam, the exhaust primary cam, and the exhaust rebreathe cam.

5. The MCC engine of claim 3, further comprising an intake camshaft and an exhaust camshaft arranged in a double overhead camshaft arrangement, wherein the intake camshaft comprises the intake primary cam and the exhaust camshaft comprises the exhaust primary cam and the exhaust rebreathe cam.

6. The MCC engine of claim 3, wherein the portion of the time that the intake valve is open occurs during a second half of the time that the intake valve is open.

7. The MCC engine of claim 3, wherein a valve lift maximum extent of the exhaust valve during the portion of the time that the intake valve is open occurs after a valve lift maximum extent of the intake valve occurs.

8. The MCC engine of claim 1, further comprising a variable geometry turbocharger (VGT) connected downstream of the exhaust valve, wherein the VGT is operable to vary a quantity of trapped residuals in the rebreathed exhaust.

9. The MCC engine of claim 8, wherein the VGT is operable to control a pressure in an exhaust port in response to an identification of the fuel.

10. The MCC engine of claim 8, wherein the VGT is operable to control a pressure in an exhaust port in response to engine operating conditions.

11. The MCC engine of claim 1, wherein a pressure of the rebreathed exhaust is 220 kPa or more.

12. The MCC engine of claim 1, wherein up to 50% of the combustion chamber gas is rebreathed exhaust.

13. The MCC engine of claim 11, wherein between 10-30% the combustion chamber gas is rebreathed exhaust.

14. The MCC engine of claim 1, wherein an intake valve close (IVC) temperature in the cylinder is at least 480 K.

15. The MCC engine of claim 1, wherein a start of injection (SOI) temperature is at least 1200 K.

16. A method of mixing controlled compression ignition of a low reactivity fuel, the method comprising:
opening an intake valve for an intake stroke to draw air into a cylinder;
opening an exhaust valve for exhaust rebreathe during the intake stroke to draw exhaust gas and exhaust residuals into the cylinder;
closing the exhaust valve and the intake valve;
initiating a compression stroke at a cylinder gas temperature elevated by the exhaust gas and exhaust residuals;
direct injecting the low reactivity fuel into the cylinder; and
compression igniting the low reactivity fuel.

17. The method of claim 16 further comprising:
controlling a pressure of the exhaust gas in an exhaust port with a variable geometry turbocharger (VGT) connected to the exhaust port downstream of the exhaust valve.

18. The method of claim 17, wherein the pressure in the exhaust port during the exhaust rebreathe is 220 kPa or more and up to 50% of gas in the cylinder is exhaust gas and exhaust residuals.

19. The method of claim 16 further comprising:
opening the exhaust valve for an exhaust stroke with a primary exhaust cam;
wherein opening the intake valve further comprises opening the intake valve with a primary intake cam; and
wherein opening the exhaust valve for exhaust rebreathe further comprises opening the exhaust valve with a rebreathe cam.

20. The method of claim 16 wherein a temperature in the cylinder when the intake valve closes is at least 480 K.
